(19) United States
(12) Patent Application Publication
(10) Pub. No.: US 2023/0039207 A1
(43) Pub. Date: Feb. 9, 2023

(54) Fishing Net with Magnetic Clasp System

(71) Applicant: Texas Customs, Inc., Coleman, TX (US)

(72) Inventors: Jeffrey Leornard Slusher, Coleman, TX (US); Fernando Cristan, Rowlett, TX (US)

(21) Appl. No.: 17/966,844

(22) Filed: Oct. 16, 2022

Related U.S. Application Data
(63) Continuation of application No. 17/138,921, filed on Dec. 31, 2020.

(51) Int. Cl. A01K 75/00; A01K 77/00

(52) U.S. Cl. CPC A01K 75/00; A01K 77/00

(57) ABSTRACT

A kit for making an improved fishing net is disclosed that incorporates a magnetic clasp system into its structure. The kit introduces a medallion containing a magnet having a force of attraction of at least 1.8 kilograms attached to a bottom portion of any fishing net. Iron or magnet in any form, be it solid, powder or liquid, is inserted within the fishing net pole at a location where the medallion is located when holding the fishing net vertically with the net up, so that the magnetic force of the magnet(s) and/or iron causes the net to connect to the pole.

### CROSS REFERENCE TO RELATED APPLICATIONS

This application is a divisional of U.S. patent application Ser. No. 17/138,921 and claims priority to U.S. patent application Ser. No. 17/138,921 filed Dec. 31, 2020. The entire contents of U.S. patent application Ser. No. 17/138,921 are incorporated herein by reference.

### BACKGROUND OF THE INVENTION

Without a holding mechanism that keeps a fishing net connected to its pole, the net often becomes tangled and difficult to control when netting a fish. U.S. Pat. No. 6,681,515, issued to Grill in January 2004 solved many of the problems inherent in the prior art and satisfied the need at that time for an improved fishing net with a clasp system. Grill used a holding device made of fasteners that basically wrapped a water resistant material around the fishing net and pole, holding the fishing net to the pole with Velcro. This was difficult and cumbersome to use. U.S. Pat. App. No. 20200296943, (hereinafter “Mast”) provided a partial solution to Grill's bulky and cumbersome approach by using a magnet and coupling device to mount a magnet on the pole and connecting a piece of iron or magnet to the bottom portion of the net. Admittedly, this is less bulky and cumbersome than Grill; however, it still has unnecessary extra mechanical elements mounted to the pole that are not necessary and must be tightened and maintained throughout the useful life of the fishing net.

Aluminum and other light metals are used to make conventional fishing net poles because iron rusts and is heavier, making an iron pole unsuitable for a fishing net with a magnetic clasp system. Unfortunately, magnets are not magnetically attracted to conventional fishing net poles, which led to the prior art attempts by Grill and Mast. A need now exists for an improved, more efficient, fishing net with magnetic clasp system which incorporates just enough magnetic material into an approximately one inch portion of the pole to be attractive to the magnetic material connected to the bottom portion of the net, inclusive of any necessary extensions of the net to make any odd or cup shaped nets long enough to reach the magnetic material inside the pole. This monolithic structural improvement makes it is much lighter than a fully iron fishing net pole, making it a feasible solution. In short, a fishing net with magnetic clasp systems that is structurally monolithic eliminates the unnecessary structure mounted externally and requires no maintenance over the useful life of the fishing net. This improved fishing net with magnetic clasp system is much less cumbersome to use than Grill and Mast, and looks like a simple fishing net, but for the medallion containing magnetic material on the net.

### SUMMARY OF THE INVENTION

An improved fishing net with magnetic clasp system is presented that solves the problems not resolved by prior art attempts by introducing magnetic material into the structure of the fishing net pole monolithically rather than mounted to the pole externally, making it less cumbersome to use, and easier to maintain over its useful life. The present invention comprises:

A. A kit of supplies for creating a magnetic clasp system for a fishing net, comprising:
(a) approximately 28 grams magnetic material;
(b) approximately 56 grams filler material;
(c) a medallion containing a magnet having at least 1.8 kilograms force of attraction; and
(d) a fastener.
B. The kit of supplies of A above, further comprising:
(e) at least one cap having at least a 0.3 centimeter diameter.
C. The kit of supplies of A above, further comprising:
(f) at least one drill bit having at least a 0.3 centimeter diameter.
D. The kit of supplies of A above, further comprising
(g) at least one alcohol wipe.
E. The kit of supplies of A above, wherein said magnetic material of (a) is iron.
F. The kit of supplies of A above, wherein said magnetic material of (a) is liquid magnet.
G. The kit of supplies of A above, wherein said filler material of (b) is silicon.
H. The kit of supplies of A above, wherein said fastener of (d) is a zip tie.
I. The kit of supplies of A above, wherein said fastener of (d) is a carabineer.
J. The kit of supplies of A above, wherein said fastener of (d) is a key ring.
K. The kit of supplies of A above, wherein said fastener of (d) is fixedly monolithic with the medallion of (c).

The many objects and advantages of the present invention will become apparent to those skilled in the art when the following detail description of the invention and some of its various preferred embodiments are reviewed along with the attached drawings wherein like reference numerals refer to like components throughout. The variously described embodiments of the present invention have many advantages, but the invention is not limited by only the embodiments described herein. Although the present invention will be described in considerable detail with reference to certain preferred embodiments thereof, other alternative embodiments are possible. Therefore, the spirit and scope of the claims should not be limited to the description of the preferred embodiments, nor the alternative embodiments, contained herein.

### BRIEF DESCRIPTION OF THE DRAWINGS

FIG. 1 is a perspective view of an exemplary embodiment of the fishing net with magnetic clasp system according to the invention right after original manufacture.

FIG. 2 is a perspective view of an exemplary embodiment of the fishing net with magnetic clasp system according to the invention when installed into an existing fishing net using one hole drill into the fishing net pole.

FIG. 3A is a perspective view of an exemplary embodiment of the fishing net with magnetic clasp system according to the invention when installed into an existing fishing net using two holes drill into the fishing net pole.

FIG. 3B is a cross sectional view of FIG. 3A, pole 230.

FIG. 4A is medallion 340, which can be seen as 040 of FIG. 1, 140 of FIG. 2 and 240 of FIG. 3A with monolithic fastener clip structurally part of the medallion.

FIG. 4B depicts various sized caps 360, which is also shown in FIGS. 3A-B as 260, that is an optional feature of some of the various embodiments of the invention.

FIG. 4C depicts an optional drill bit 350 for creation of holes 150 of FIGS. 2, and 250 of FIGS. 3A-B.

FIG. 4D depicts optional alcohol wipes 390 for creation of various embodiments of the invention for cleanup purposes.

FIG. 4E depicts iron shavings 370 (sometimes called “Magnetite”), preferably in the form of a fine powder.

FIG. 4F depicts shavings of a magnet 380, preferably in the form of a fine powder.

FIG. 4G depicts a tube of liquid iron 310.

FIG. 4H depicts a tube of liquid magnet 320.

FIG. 4I depicts a tube of silicon or other filler material 330.

FIG. 4J shows an optional key 430 that can be included in a product kit for use in various preferred embodiments of the invention to assist installation of the magnetic clasp system of the invention on a pre-existing conventional fishing net.

FIG. 4K depicts a carabiner clip 420 (also spelled “carabineer”) which is used as an optional fastener of a medallion with hole 540 in various contemplated embodiments of the invention.

FIG. 4L depicts a conventional zip tie 440 which is used as an optional fastener of a medallion with hole 540 in various contemplated embodiments of the invention.

FIG. 4M depicts a conventional key ring 450 which is used as an optional fastener of a medallion with hole 540 in various contemplated embodiments of the invention.

### DETAILED DESCRIPTION OF SOME PREFERRED EMBODIMENTS

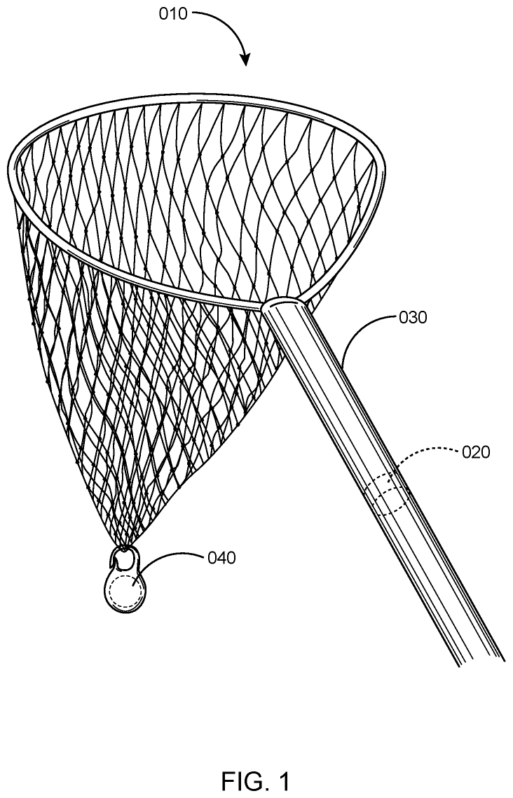

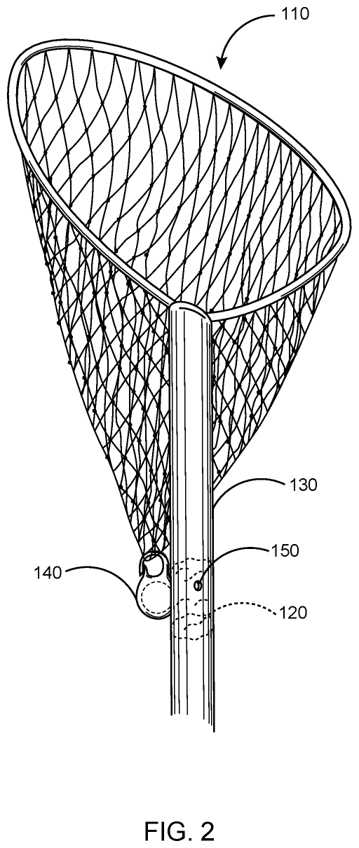

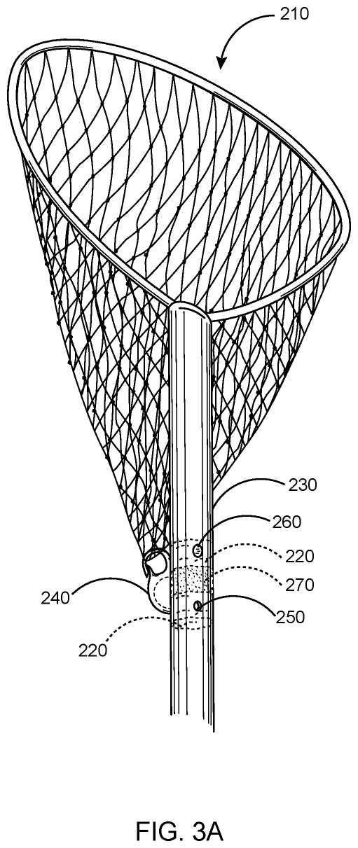

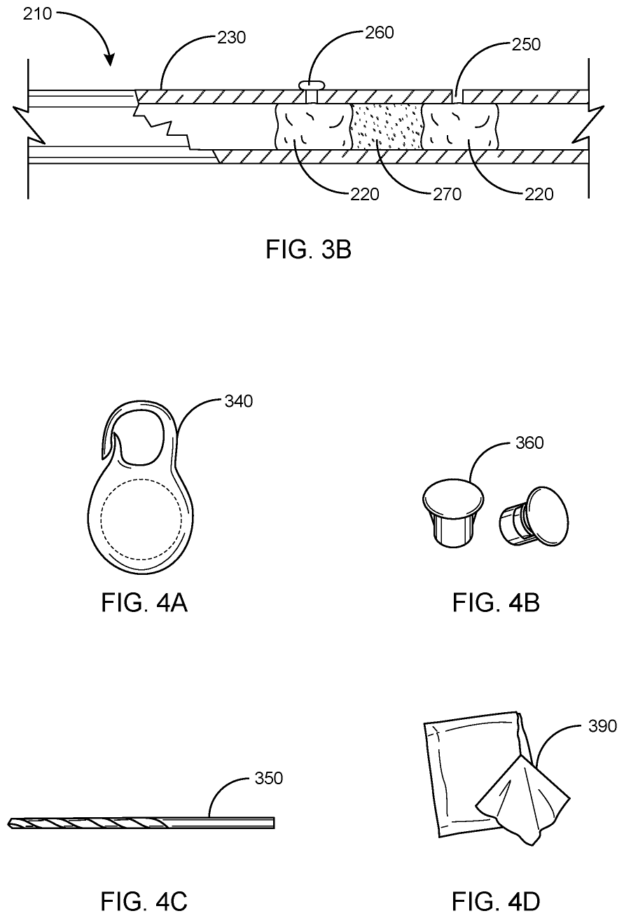

The present invention relates to a new type of fishing net FIG. 1, 010 or the modification of any preexisting, conventional fishing nets FIG. 2, 110 and FIG. 3A, 210. The manufacture of a new type of fishing net, FIG. 1, 010 that has a medallion 040 connected to a bottom portion of the net 010, inclusive of any necessary net extensions, and which has magnetic material 020 such as iron or at least one magnet inserted inside its pole 030, is contemplated in a more general embodiment as recited in the claims of the invention as follows: A fishing net 010 comprising a pole 030 with at least 20 grams magnetic material 020 fixedly inserted inside and substantially filling an area of at least 2 centimeters length of the pole 030, a net 010 mounted with respect to the pole 030, and a medallion magnet 040 mounted to a bottom portion of the net 010, inclusive of any necessary extensions of the net to make any odd or cup shaped nets long enough to reach the magnetic material inside the pole. The magnetic material 020 is positioned inside the pole 030 at a location less than 2.5 centimeters from where the medallion magnet 040 is with respect to the pole 030 when holding the pole vertically, net up, as depicted in FIG. 1.

FIGS. 2-3A show preexisting conventional fishing nets 110 and 210, respectively, that show various optional methods of installation to create a fishing net with a magnetic clasp system according to various optional embodiments of the invention by drilling one and two holes, respectively. The method steps described in the claims have the following steps:

(a) connecting a magnet FIGS. 2-3A, 140, 240 to a bottom portion of the respective nets 110 and 210, respectively, inclusive of any net extensions for odd shape nets having no tail;
(b) drilling at least one hole FIGS. 2-3B, 150, 250 into their poles 130 and 230 at a location 120, 220 less than 3 centimeters from where the magnet 140, 240 is with respect to the pole 130, 230 when holding the pole vertically, net up; and
(c) substantially filling the inside of the pole with at least 20 grams magnetic material FIGS. 3A-B, 270 substantially occupying an area of at least 2 centimeters along the length of the pole fixedly adjacent said at least one hole 150, 250, 260 (hole and cap 260). In one embodiment, magnetic material 270 is fixedly surrounded by at least 20 grams of filler 220 material on both sides of the magnetic material 270 inside the poles FIGS. 2-3A 130, 230, respectively.

In the single hole 150 embodiment of FIG. 2 (without cap shown), it is contemplated that the magnetic material would fill the void outlined by the location 120 for fixedly inserting liquid iron or liquid magnet into the void directly in the hole 150 without the need for any filler material. At least 20 grams of magnetic material is sufficient for the magnet 140 to connect to the pole 130.

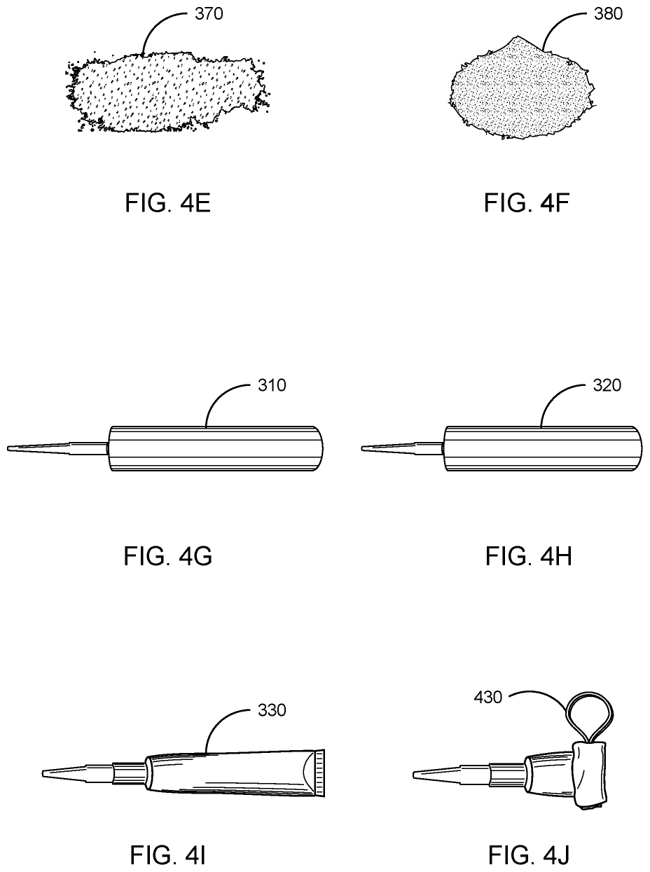

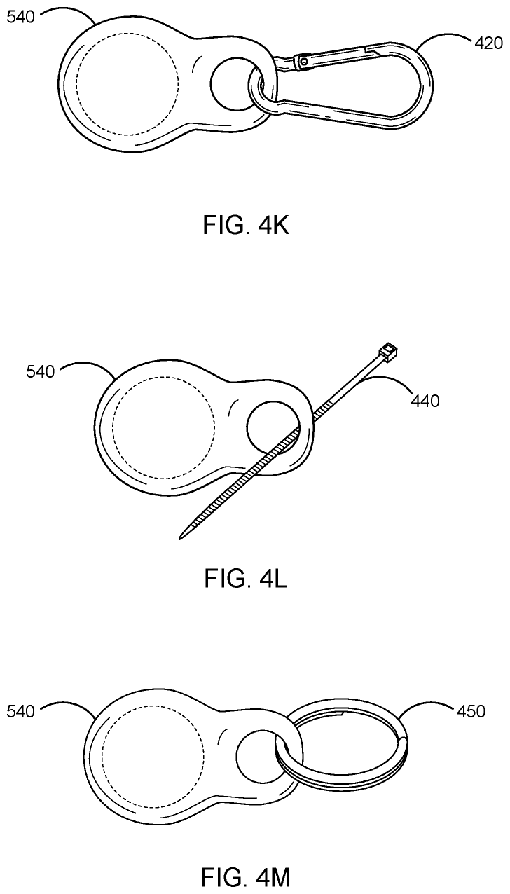

In all contemplated embodiments of the invention, medallion 040, 140, 240 can optionally be monolithic FIG. 1, 040 and FIG. 4A, 340 with the fastener, or have a small hole for receiving a zip tie FIG. 4L, 440, a carabineer FIG. 4K, 420, a key chain FIG. 4M, 450 or some other clip or connector, to connect the medallion 540 to a bottom portion of the net, inclusive of necessary extensions to the net.

In either the one hole or two hole or more embodiments, a kit of supplies for creating a magnetic clasp system for a fishing net, would comprise:

(a) approximately 28 grams magnetic material FIGS. 4E-H, 370 solid iron, 380 solid magnet, 310 liquid iron and/or 320 liquid magnet respectively, but at least 20 grams is required;
(b) approximately 56 grams filler material like silicon FIG. 4I, 330, but it could instead use any type of filler that bonds to a conventional fishing pole, like foam, epoxy resin, etc. (not shown). A key FIG. 4J, 430 for fully dispensing silicon, 330, liquid iron 310 or quid magnet 320, is also helpful;
(c) a medallion FIGS. 1-3A, FIG. 4A, FIGS. 4K-4M, 040, 140, 240, 340, 420, 440 and 450 containing a magnet having at least 1.8 kilograms force of attraction is necessary a good connection; and
(d) a fastener FIG. 4A, 4K-4M.

The kit of supplies could optionally also include the following supplies:

(e) at least one cap FIG. 4B, 360 having at least a 0.3 centimeter diameter;
(f) at least one drill bit FIG. 4C, 350 having at least a 0.3 centimeter diameter;
(g) at least one alcohol wipe FIG. 4D, 390;

The foregoing detailed description is to be clearly understood as given by way of illustration and example only, the spirit and the scope of this invention being limited solely by the claims.

What is claimed is:

1. A kit of supplies for creating a magnetic clasp system for a fishing net, comprising:
(a) approximately 28 grams magnetic material;
(b) approximately 56 grams filler material;
(c) a medallion containing a magnet having at least 1.8 kilograms force of attraction; and
(d) a fastener.

2. The kit of supplies of claim 1, further comprising:
(e) at least one cap having at least a 0.3 centimeter diameter.

3. The kit of supplies of claim 1, further comprising:
(f) at least one drill bit having at least a 0.3 centimeter diameter.

4. The kit of supplies of claim 1, further comprising
(g) at least one alcohol wipe.

5. The kit of supplies of claim 1, wherein said magnetic material of (a) is iron.

6. The kit of supplies of claim 1, wherein said magnetic material of (a) is liquid magnet.

7. The kit of supplies of claim 1, wherein said filler material of (b) is silicon.

8. The kit of supplies of claim 1, wherein said fastener of (d) is a zip tie.

9. The kit of supplies of claim 1, wherein said fastener of (d) is a carabineer.

10. The kit of supplies of claim 1, wherein said fastener of (d) is a key ring.

11. The kit of supplies of claim 1, wherein said fastener of (d) is fixedly monolithic with the medallion of (c).
